(19) United States
(12) Patent Application Publication
(10) Pub. No.: US 2008/0095393 A1
(43) Pub. Date: Apr. 24, 2008

(54) In-Ear Headphone

(75) Inventors: Erich Klein, Himberg (AT); Michael Schoeffmann, Siegenfeld (AT)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/720,187

(22) PCT Filed: Nov. 16, 2005
(86) PCT No.: PCT/IB05/53783

§ 371 Date: May 24, 2007

(30) Foreign Application Priority Data
Nov. 24, 2004 (EP) 04106042.7

(51) Int. Cl. H04R 25/00

(52) U.S. Cl. 381/380

(57) ABSTRACT

An in-ear headphone (1) comprising an elastic sealing part (2) and a solid sealing part (3) for sealing an ear cavity (b) against an outside region (c) is disclosed, wherein said solid sealing part (3) comprises at least one damping vent (4) interconnecting the ear cavity (b) and the outside region (c), and wherein said damping vent (4) forms an acoustic friction.

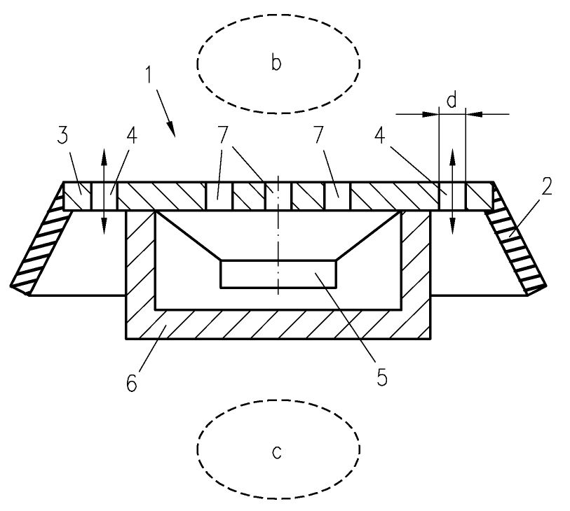

### FIELD OF THE INVENTION

The invention relates to an in-ear headphone. The invention furthermore relates to a solid sealing part of an in-ear headphone as well as to an elastic sealing part of an in-ear headphone.

### BACKGROUND OF THE INVENTION

An in-ear headphone closes the auditory meatus of an ear, the in-ear headphone and the auditory meatus defining a cavity within the ear. A reproduction of sound is very much influenced by the resonance characteristic of this in-ear cavity. For a high quality reproduction of sound it is necessary to damp resonances of the in-ear cavity. The in-ear headphone usually comprises a cap of foam material for closing the auditory meatus for the purpose of damping resonances of the in-ear cavity, which cap is drawn over a housing of the headphone. This cap performs two functions, the first of which is to seal the ear against the outside region, and the second of which is to damp the resonance frequency of the in-ear cavity by providing some air ventilation. It is a disadvantage of the headphones according to the state of the art that the sealing and damping functions depend on each other and also on the size of the wearer's ear, which squeezes the foam to a greater or lesser extent. Thus the reproduction of sound is accidentally influenced by the actual mounting condition of the cap. This is why a good sound reproduction cannot be ensured.

JP 08-037697A describes a hearing aid with a base body from which a sealing part projects, which sealing part closes the auditory meatus of a user's ear. The sealing part comprises a closeable through hole connecting the ear cavity to an exterior space outside the ear. The through hole forms an acoustic mass, one function of the through hole being to improve the wearing comfort of the hearing aid by avoiding a feeling of sealing of the ear. Another function of the through hole is to increase the sound level within a frequency range of 300 Hz to 1 kHz without increasing the electrical amplifying power. Thus said through hole acts as an amplifier for acoustic frequencies inside the ear cavity. It is a disadvantage of the known hearing aid that, because of its dimensions and construction, it is not suitable for damping resonances of the in-ear cavity.

It is an object of the invention to provide an in-ear headphone of the type defined in the opening paragraph, a solid sealing part of an in-ear headphone of the type defined in the second paragraph, and an elastic sealing part of an in-ear headphone of the type defined in the third paragraph such that the disadvantages defined above are avoided.

### OBJECT AND SUMMARY OF THE INVENTION

In order to achieve the object defined above, characteristic features are provided in an in-ear headphone according to the invention such that an in-ear headphone according to the invention can be characterized as follows: an in-ear headphone, comprising an elastic sealing part and a solid sealing part for sealing an ear cavity against an outside region, wherein said solid sealing part comprises at least one damping vent for interconnecting the ear cavity and the outside region, and wherein said damping vent forms an acoustic friction.

In order to achieve the object defined above, characteristic features are provided in a solid sealing part of an in-ear headphone according to the invention such that a solid sealing part of an in-ear headphone according to the invention can be characterized as follows: a solid sealing part for an in-ear headphone comprising an area prepared for connection to an elastic sealing part and comprising at least one damping vent for interconnecting an ear cavity and an outside region, wherein said damping vent forms an acoustic friction.

In order to achieve the object defined above, characteristic features are provided in an elastic sealing part of an in-ear headphone according to the invention such that an elastic sealing part of an in-ear headphone according to the invention can be characterized as follows: an elastic sealing part for an in-ear headphone for sealing an ear cavity against an outside region, which elastic sealing part comprises an area prepared for connection to a solid sealing part.

The characteristic features according to the invention provide the advantage that a good sound reproduction within a broad frequency range is achieved.

If at least one damping vent is realized as a hole or slit, the advantage is provided that the vents can be produced very easily.

It is furthermore advantageous if the at least one damping vent has a width smaller than or equal to 0.5 mm. This provides the advantage that a good damping function is achieved.

Yet another advantageous embodiment of the invention is an in-ear headphone, wherein the elastic sealing part is made of a material which is impermeable to air. This provides the advantage of a good sealing function of the headphone.

Finally, it is beneficial if the elastic sealing part is a cone made of silicone, which provides a good sealing function of the headphone. Moreover, silicone is a material which is comfortable to wear.

### BRIEF DESCRIPTION OF THE DRAWINGS

The invention will be described in more detail below with reference to a preferred embodiment to which, however, the invention is not limited. The accompanying FIGURE shows a cross-section of an inventive in-ear headphone.

The FIGURE is schematically drawn and not true to scale. It will be clear to those skilled in the art that alternative but equivalent embodiments of the invention are possible without deviating from the true inventive concept, and that the scope of the invention will be limited by the claims only.

### DESCRIPTION OF EMBODIMENTS

An in-ear headphone 1 according to the invention comprises an elastic sealing part 2 and a solid sealing part 3 for sealing an ear cavity b against an outside region c. The solid sealing part 3 is manufactured as a solid plate covering the sound radiation side of a loudspeaker 5, which loudspeaker 5 is arranged within a housing 6. Through holes 7 for sound radiation are arranged in a central portion of the plate, while a portion of the plate protruding laterally from the housing 6 comprises damping vents 4. The portion comprising the damping vents 4 forms an edge that radially surrounds the housing 6.

The central portion comprising the sound radiation through holes 7 and the portion comprising the damping vents 4 may alternatively be formed as separate parts. The solid sealing part 3 is preferably made of plastics.

The damping vents 4 of the solid sealing part 3 connect the ear cavity b to the outside region c in a mounted state of the in-ear headphone 1, wherein the damping vents 4 each form an acoustic friction. This means that each damping vent 4 damps acoustic waves inside the in-ear cavity b, particularly in the range of the resonance frequency of the cavity b. The damping vents 4 according to the invention smoothen the frequency response of the sound pressure level in the in-ear cavity b. This means that the frequency response of the sound pressure level is essentially made constant or steady.

As is shown in the FIGURE, the damping vents 4 have the shape of cylindrical holes or slits, each hole or slit forming a duct. The damping vents 4 each have a width d smaller than or equal to 0.5 mm to provide a good damping effect. The damping vents 4, however, preferably have a width d approximately between 0.1 and 0.5 mm for reasons of manufacture.

It is possible in principle that just one damping vent 4 is provided. In this case the damping vent 4 may be formed, for example, as a long slit.

The elastic sealing part 2 is arranged around the solid sealing part 3, with the elastic sealing part 2 and the solid part 3 connected to each other, for example, by an adhesive bond such as gluing. It is also possible simply to stick the elastic sealing part 2 and the solid part 3 together. The elastic sealing part 2 is connected to the solid sealing part 3 in a manner such that the elastic sealing part 2 protrudes from the solid sealing part 3 towards the outside region c if the in-ear headphone 1 is mounted in an ear.

Furthermore, the elastic sealing part 2 is made of a material impermeable to air so as to improve the sealing function of the elastic sealing part 2. The elastic sealing part 2 is preferably made of silicone, since this material provides a good fit against a user's ear, although any other elastic material impermeable to air, e. g. rubber, may be used in principle for manufacturing the elastic sealing part 2.

The elastic sealing part 2 is formed as a cone in order to improve the sealing function of the elastic sealing part 2 and to close off the ear cavity b very effectively against the outside region c.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The words “comprising” and “comprises”, and the like, do not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. In-ear headphone comprising an elastic sealing part and a solid sealing part for sealing an ear cavity against an outside region, wherein said solid sealing part comprises at least one damping vent for interconnecting the ear cavity and the outside region, and wherein said damping vent forms an acoustic friction.

2. In-ear headphone as claimed in claim 1, wherein the at least one damping vent is realized as a hole or slit.

3. In-ear headphone as claimed in claim 2, wherein the at least one damping vent has a width smaller than or equal to 0.5 mm.

4. In-ear headphone as claimed in claim 1, wherein the elastic sealing part is made of a material which is impermeable to air.

5. In-ear headphone as claimed in claim 4, wherein the elastic sealing part is a cone made of silicone.

6. Solid sealing part for an in-ear headphone comprising an area prepared for connection to an elastic sealing part and comprising at least one damping vent for interconnecting an ear cavity and an outside region, wherein said damping vent forms an acoustic friction.

7. Elastic sealing part for an in-ear headphone for sealing an ear cavity against an outside region, comprising an area prepared for connection to a solid sealing part.
